(19) United States
(12) Patent Application Publication
(10) Pub. No.: US 2026/0193510 A1
(43) Pub. Date: Jul. 9, 2026

(54) TRACED CORROSION INHIBITOR FOR CLOSED LOOP SYSTEMS

(71) Applicant: CHEMTREAT, INC., Glen Allen, VA (US)

(72) Inventor: Patrick WOOD, Midlothian, VA (US)

(73) Assignee: CHEMTREAT, INC., Glen Allen, VA (US)

(21) Appl. No.: 19/426,728

(22) Filed: Dec. 19, 2025

Related U.S. Application Data
(60) Provisional application No. 63/742,619, filed on Jan. 7, 2025.

(51) Int. Cl. C09K 5/20; C09K 11/06; C23F 11/04; G01N 21/64

(52) U.S. Cl. CPC C09K 5/20; C09K 11/06; C23F 11/04; G01N 21/6428; C09K 2211/1011; G01N 2021/6439

(57) ABSTRACT

This disclosure provides methods of treating a closed loop system that includes a heat transfer fluid in contact with a corrodible metal surface such as a surface made from aluminum, carbon steel, and/or mild steel. A corrosion inhibition compound that includes a fluorophore group is combined with the heat transfer fluid. The amount of the corrosion inhibition compound in the heat transfer fluid can then be determined by measuring the fluorescence signal of the corrosion inhibition compound, and the amount of corrosion inhibition compound that is added to the heat transfer fluid can be controlled.

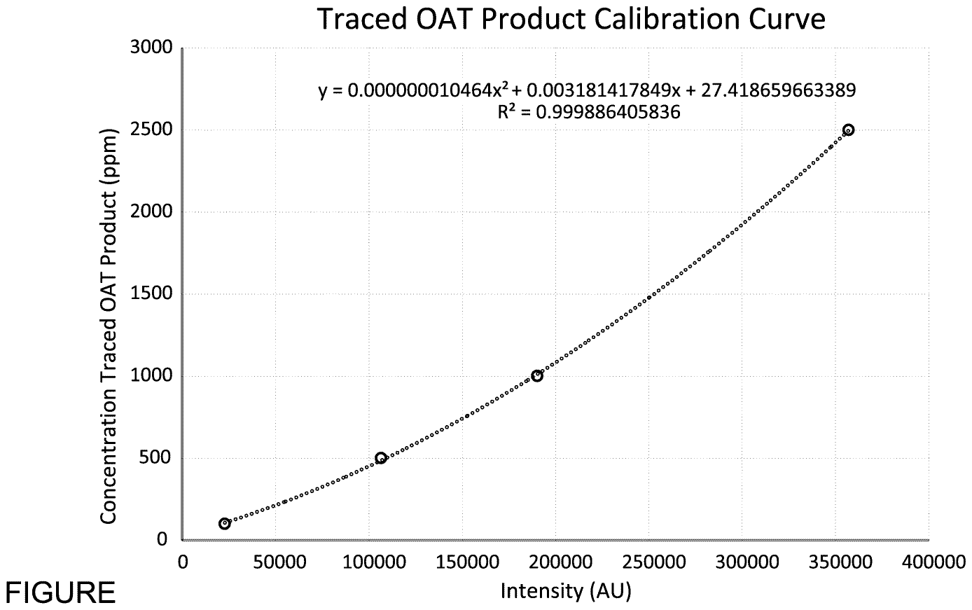

### CROSS-REFERENCE TO RELATED APPLICATIONS

This application claims the earlier filing date benefit of U.S. Provisional Application No. 63/742,619, filed on Jan. 7, 2025, which is incorporated by reference herein in its entirety.

### FIELD OF INVENTION

This invention relates generally to using a corrosion inhibitor in closed loop systems that can be detected and quantified with fluorescence detection.

### BACKGROUND

Closed loop systems circulate fluid for long periods of time, such as in boiler systems, closed loop cooling systems, and engine coolant systems. For closed loop systems with aluminum surfaces, nitrate and silica-based compositions are typically used as corrosion inhibitors that are added to the coolant fluid. For closed loop systems with mild steel surfaces, nitrite and various mono and dibasic acids are used as corrosion inhibitors that are added to the coolant fluid. However, nitrate and nitrite chemistries are subject to restrictive environmental regulations, and silica compounds can foul the equipment and conduit surfaces. Accordingly, there is a desire to reduce the use of these chemistries in closed loop systems.

The corrosion inhibitor composition can also break down over time in closed loop systems, particularly where the heat transfer fluid is subjected to high temperatures or pressures. In existing closed loop systems, the corrosion inhibitor actives are not regularly monitored and can only be quantified by conducting laboratory testing that requires specialized equipment. Thus, it is difficult to determine whether the closed loop system has an adequate concentration of active corrosion inhibitor, which can lead to under dosing or over dosing of the corrosion inhibitor compound.

### SUMMARY

Accordingly, there is a need for alternative chemistries that are effective to inhibit corrosion of corrodible metal surfaces in closed loop systems and can be more easily and effectively monitored in the field.

In accordance with one aspect, this disclosure provides a method for treating a closed loop system that includes a corrodible metal surface. The method includes steps of (i) providing a heat transfer fluid that is in contact with the corrodible metal surface and includes a naphthalene derivative, (ii) measuring a fluorescence signal of the naphthalene derivative in the heat transfer fluid, and (iii) determining an amount of the naphthalene derivative in the heat transfer fluid based on the measured fluorescence signal.

In accordance with another aspect, this disclosure provides a method for treating a closed loop system that includes a heat transfer fluid that is in contact with a corrodible metal surface including an aluminum surface, a carbon steel surface, or a mild steel surface. The method includes adding a corrosion inhibition composition to the heat transfer fluid, which includes a corrosion inhibition compound that has a fluorophore group and is effective to inhibit corrosion of the corrodible metal surface, and then measuring a fluorescence signal of the corrosion inhibition compound in the heat transfer fluid.

### BRIEF DESCRIPTION OF THE DRAWINGS

The FIGURE is a graph showing a standard curve relating the fluorescence emission intensity to a concentration of a corrosion inhibition composition that includes a naphthalene derivative compound.

### DETAILED DESCRIPTION OF EMBODIMENTS

The corrosion inhibitor compounds that are useful in the inventive methods have dual functionality in that (i) they are effective to inhibit corrosion in closed loop systems with corrodible metal surfaces, and (2) they are readily quantifiable by fluorescent detection. In accordance with this invention, the corrosion inhibitor compound can be added to any aqueous- or glycol-based heat transfer fluids that are used to transfer heat in closed loop systems. A “closed loop” system as used herein refers to a system in which a fluid is recirculated in a loop for an extended period of time without adding significant makeup fluid to the loop or removing significant blowdown of the loop, e.g., boiler water systems, engine coolant systems, air conditioning chilled water systems, etc. Closed loop systems can be characterized in that evaporation does not occur in closed loop cooling systems by design, unlike in open cooling systems. The purpose of a closed loop is to transfer heat, from a process or equipment to a second process or equipment. For example, removing heat from a combustion engine and transferring it to an air cooled radiator or transferring heat from an electric boiler to a plastic injected blow mold.

### Corrosion Inhibitor Composition

The corrosion inhibitor composition includes at least one fluorescent inhibitor compound that is effective to inhibit corrosion of a corrodible metal surface and has at least one fluorophore group, such as several combined aromatic groups, that enable fluorescent detection and quantification of the corrosion inhibitor compound. In embodiments, the corrosion inhibitor composition is effective to inhibit corrosion of aluminum surface, mild steel surface, and/or carbons steel surfaces, for example.

The corrosion inhibitor compound can be a naphthalene derivative having the Formula (I) below.

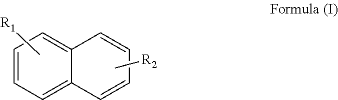

In Formula (I), at least one of R1 and R2 includes (i) a sulfonic acid group (—SO₂OH) or anions, salts, or esters thereof, or (ii) a carboxylic acid group, or anions, salts, or esters thereof. Where only one aromatic ring of the naphthalene derivative is substituted (i.e., only one of R1 and R2), the other aromatic group can be unsubstituted. In embodiments, both aromatic groups are substituted, and R1 and R2 can be the same group or can be different groups. In embodiments, R1 and R2 can be substituted at the 1,5 positions, or at the 2,6 positions, for example. Examples that produce an adequate fluorescence signal and inhibit corrosion on metal surfaces 1,5-sodium naphthalene disulfonate and 2,6-naphthalene dicarboxylic acid.

The corrosion inhibitor composition can be provided as a solution having from 0.001 wt. % to 25 wt. % of the fluorescent inhibitor compound, 0.05 wt. % to 10 wt. % of the fluorescent inhibitor compound, 0.1 wt. % to 5 wt. % of the fluorescent inhibitor compound, or 0.2 wt. % to 2 wt. % of the fluorescent inhibitor compound. The solution can be an aqueous solution that is primarily water and/or glycol. The corrosion inhibitor composition can have a combined amount of water and glycol that is at least 40 wt. %, at least 50 wt. %, at least 75 wt. % or at least 90 wt. %.

The corrosion inhibitor composition can include other additives, including other corrosion inhibitor agents such as a C6-C14 aliphatic dicarboxylic acid (e.g., sebacic acid, dodecanedioic acid), a C6-C14 aliphatic monocarboxylic acid (e.g., hexanoic acid, 2-ethyl hexanoic acid, heptanoic acid, isoheptanoic acid, octanoic acid, nonanoic acid, neodecanoic acid, decanoic acid dodecanoic acid), an azole (e.g., tolyltriazole, benzotriazole, chlorinated tolyltriazoles, and brominated tolytriazoles), or any combinations of these additional corrosion inhibitor agents. For example, the corrosion inhibitor composition can include a naphthalene derivative and a total amount of these C6-C14 organic acids in a weight ratio in a range of from 1:20,000 to 1:1, from 1:100 to 1:1, from 1:50 to 1:5, or from 1:25 to 1:10, or otherwise the naphthalene derivative and the C6-C14 organic acid(s) can be dosed in the closed loop system in these relative amounts. The corrosion inhibitor composition can include a naphthalene derivative and a total amount of azoles in a weight ratio in a range of from 1:2,000 to 10:1, from 1:10 to 10:1, from 1:4 to 4:1, or from 1:2 to 2:1, for example, or otherwise the naphthalene derivative and the azole(s) can be dosed in the closed loop system in these relative amounts. The corrosion inhibitor composition can also include nitrate, phosphate, or silica compounds in amounts of from 0.05 wt. % to 5 wt. %, for example, but in some embodiments does not include those compounds, or includes only insignificant amounts of those compounds, e.g. less than 0.01 wt. %.

For the reasons explained below, the corrosion inhibitor composition can also include an inert fluorescent tracer, such as pyrenetetrasulfonic acid tetra sodium salt (PTSA), in amounts of from 0.005 wt. % to 1 wt. %, or from 0.01 wt. % to 0.5 wt. %, or from 0.02 wt. % to 0.2 wt. %.

In some aspects, the corrosion inhibitor composition can include or be administered together with any of the compositions described in Provisional Application No. 63/680,296, filed on Aug. 7, 2024, the entirety of which is incorporated by reference herein. These additional corrosion inhibitor agents may improve corrosion inhibition when the closed loop system includes components made of yellow metals, in addition to aluminum and/or steel.

### Treatment Methods

This disclosure also provides methods of inhibiting corrosion on metal surfaces in closed loop systems by combining one or more of the fluorescent inhibitor compounds described above with a heat transfer fluid that contacts the metal surfaces. As shown below, the treatment compositions have been shown to provide excellent corrosion protection on various metals in closed loop systems, in particular closed loop systems with aluminum surfaces, carbon steel surfaces, and/or mild steel surfaces. The term “aluminum” as used herein includes aluminum and aluminum-based alloys, and “mild steel” refers to steels have an amount of carbon that is less than 0.25 wt. %.

In some embodiments, the fluorescent inhibitor compound shows efficacy in inhibiting corrosion on other types of metal in addition to aluminum, carbon steels, and mild steels, including other steels, solder, copper, or brass. In these embodiments, the treatment methods can be useful in closed loop systems with mixed metals, such as where the heat transfer fluid is in contact with aluminum, carbon steel, and/or mild steel as well as at least one of these other metals.

The treatment method can include adding the corrosion inhibitor composition directly to the fluid that recirculates in the closed loop system, including adding it to the fluid when the system is offline, while the fluid is circulating, and/or by adding the composition to the makeup fluid, for example.

The heat transfer fluid can be cooling water or other aqueous fluid that is typically predominantly water or predominantly glycol. The heat transfer fluid is in contact with corrodible metal surfaces in the system that are part of conduits or equipment. In some cases, the heat transfer fluid may have a pH that is in a range of from 5 to 12, from 7 to 11, or from 8 to 10, for example. Aqueous fluids can have a temperature in the closed loop system that is maintained in a range of from 25 to 100° C. or from 50° C. to 80° C., for example, and up to 350° C. in pressurized loops. Glycol-based fluids in the closed system can have temperatures of from 25 to 200° C., for example. Aqueous fluids can have a Malk (total alkalinity as CaCo3) in a range of from 5 to 10,000 ppm or from 25 to 250 ppm, for example, can have chlorides in an amount of from 1 ppm to 2000 ppm or from 5 ppm to 100 ppm, for example, and can have sulfate in an amount of from 5 ppm to 100 ppm or from 20 ppm to 50 ppm, for example.

The treatment methods include adding a sufficient amount of the fluorescent inhibitor compound described above so that it is present in the recirculating fluid in an amount of at least 10 ppb, such as from 100 ppb to 2,000 ppm, from 5 ppm to 1,500 ppm, from 10 ppm to 1,000 ppm, 20 ppm to 500 ppm, from 25 ppm to 250 ppm, or from 40 ppm to 100 ppm, for example.

The methods can provide excellent corrosion inhibition over long periods of time in closed loop systems. For example, even with a single dosing of the corrosion inhibitor, the corrosion rate can be maintained to be less than 1 mpy, less than 0.5 mpy, less than 0.15 mpy, or less 0.10 mpy over at least a consecutive eight hour period.

In embodiments, the recirculating fluid can be treated to inhibit corrosion without the presence of nitrates, nitrites, phosphates, or silica compounds, or with only insignificant amounts of those components such as less than 1 ppm, or less than 0.25 ppm of each.

In embodiments, a buffer can also be added to the heat transfer fluid, either as part of the corrosion inhibitor composition or separately. The buffer can be triethanolamine or borax, for example.

### Detection and Control Methods

The fluorescent inhibitor compound in the corrosion inhibitor composition has a fluorophore that can be induced to fluoresce so that the amount of active inhibitor compound in the closed loop system can be quantified.

Fluorescence of the fluorophore may be induced by applying an amount of energy to the heat transfer fluid. The energy may be in the form of electromagnetic radiation, such as ultraviolet (UV) light, at a particular wavelength suitable for exciting the fluorophore. Electromagnetic radiation may also include infrared or visible light. The absorption of light by the fluorophore at a certain wavelength can be measured as the compound's excitation signal, or the emission of light at a certain wavelength after the compound has been exposed to an excitation wavelength can be measured as the compound's emission signal. In embodiments, the fluorescence signal can be measured at a wavelength that corresponds to the peak intensity of emission or absorption, although it is also possible to correlate the amount of the fluorescent inhibitor compound at wavelengths other than the peak emission/absorption wavelengths. As an example, the fluorophore can have a maximum excitation wavelength in a range of about 280 to 400 nm, or 300 nm to 340 nm, and can have a maximum emission wavelength in a range of about 280 to 600 nm, or 310 nm to 375 nm.

The fluorescence signal intensity changes based on the amount of active corrosion inhibitor compound that is present in the heat transfer fluid. In particular, the fluorescence signal intensity is typically directly proportional to the amount of fluorescent corrosion inhibitor compound, which allows for a direct correlation of fluorescence signal intensity to corrosion inhibitor concentration in the heat transfer fluid. A standard curve can be determined in advance based on the relationship between the intensity of the fluorescence signal and known concentrations of the corrosion inhibitor compound. The residual amount of corrosion inhibitor compound in closed loop system can then be quantified by comparing the measured fluorescence signal value to the standard curve.

The heat transfer fluid can be sampled from the closed loop system periodically or intermittently and the fluorescence signal intensity of the fluid sample can be measured with a fluorescence detector (e.g., a handheld or bench top fluorimeter). Alternatively, an in-line fluorescence detector can be used in which a fluorimeter is integrated with a portion of the closed loop system, e.g., where a portion of the heat transfer fluid in the system is diverted to a side stream or slip stream that can be read by the fluorimeter continuously or on-demand.

The amount of corrosion inhibitor compound added to the heat transfer fluid can be controlled based on the detected residual amount of corrosion inhibition compound in the system. For example, the determined amount of corrosion inhibition compound from the fluorescence signal can be compared to a predetermined threshold value, and if the amount of the corrosion inhibition compound is below the threshold value, more corrosion inhibitor composition can be added to the closed loop system.

In some embodiments, an inert fluorescent tracer such as PTSA can be dosed together with the fluorescent corrosion inhibitor compound at a predetermined ratio. The inert tracer would not be expected to break down significantly over time, and thus the residual amounts of the fluorescent corrosion inhibition compound in the heat transfer fluid can also be evaluated by measuring the fluorescence signals of the corrosion inhibition compound and the inert tracer and then comparing the fluorescence signal of the corrosion inhibitor compound with the fluorescence signal of the inert tracer. Thus, for example, if the ratio of the fluorescence signal of the corrosion inhibition compound to the fluorescence signal of the inert tracer drops below a predetermined threshold value, the amount of the corrosion inhibition composition added to the closed loop system can be increased. In this way, it is possible to evaluate the amount of active corrosion inhibition compound that remains in the closed loop system without necessarily using a standard curve.

It is also possible that the amount of corrosion inhibitor composition in the closed loop system can be automatically and/or continuously, intermittently, or periodically controlled by a controller that adjusts the amount of corrosion inhibitor that is added to the heat transfer fluid based on one or more feedback loop mechanisms (e.g., PID controller) based on the fluorescence readings. In this regard, the corrosion inhibitor composition can be present in a container that is fluidly connected to the closed loop system via one or more pumps and/or valves that are configured to receive a control signal from the controller and meter an amount of the corrosion inhibitor composition into the closed loop system based on the received control signal.

The controller can include hardware, such as a circuit for processing digital signals and/or a circuit for processing analog signals, for example. The controller may include one or a plurality of circuit devices (e.g., an IC) or one or a plurality of circuit elements (e.g., a resistor, a capacitor) on a circuit board, for example. The controller may include one or more processors (e.g., one or more CPUs) programmed to perform the control methods described herein. The controller can be operatively coupled with various other components to perform the methods described herein, including a memory (e.g., that stores threshold values, look-up tables, software modules), a communication bus or communication network, a user input, and a display.

Embodiments of the disclosed methods allow for the real-time detection and quantification of the active corrosion inhibitor in the heat transfer fluid. Detection and quantification of the corrosion inhibitor can therefore be achieved more quickly, at a lower cost, and without the need for sophisticated equipment and training. This allows for greater control of the quantity of corrosion inhibitor that is added to the closed loop system, both to ensure that sufficient corrosion inhibitor is present and to ensure that excess corrosion inhibitor is not added to the system.

### EXAMPLES

### Industrial Coolant Corrosion Examples

The following experiments are intended to be predictive of corrosion inhibition behavior in an industrial coolant closed loop system. An example corrosion inhibitor composition identified in Table 1 below was prepared by combining 2.0 wt. % of naphthalene disulfonate in a water solution that also contains triethanolamine, potassium hydroxide, sebacic acid, octanoic/decanoic acid, sodium tolytriazole, an antifoam agent (L-61), and sodium nitrate. Comparative compositions were also prepared and analyzed, including a similar composition without sodium nitrate and without naphthalene disulfonate, a composition with sodium nitrate and without naphthalene disulfonate, and a control sample of 100 wt. % water.

The corrosion inhibitor composition was added to test water at a 5,000 ppm dose. The test water included 100 ppm sulfate, 100 ppm chloride, 150 ppm Malk as CaCO3, 25 ppm Ca as CaCO3, and 10 ppm Mg as CaCO3. The pH was adjusted to 8.0-8.2 and the water was heated to 176° F. Aluminum coupons (Al1100) were submerged in the test water for 3 days and the corrosion rate measured (mpy). The results are shown in Table 1 below.

TABLE 1

| | Closed Loop Composition (%) | | | |
|---|---|---|---|---|
| Component | 5000 ppm Dosage | | | |
| RO Water | 100.0 | 54.9 | 53.3 | 51.3 |
| Triethanolamine | — | 4.0 | 4.0 | 4.0 |
| 50% KOH | — | 19.0 | 19.0 | 19.0 |
| Sebacic Acid | — | 14.0 | 14.0 | 14.0 |
| Octanoic/Decanoic Acid | — | 6.0 | 6.0 | 6.0 |
| Sodium Tolytriazole | — | 2.0 | 2.0 | 2.0 |
| L-61 | — | 0.1 | 0.1 | 0.1 |
| Sodium Nitrate | — | — | 1.6 | 1.6 |
| Naphthalene | — | — | — | 2.0 |
| Disulfonate | | | | |
| Corrosion Rate (mpy) | 14.7 | 17.7 | 15.2 | 7.3 |

It can be seen from the above results that the corrosion inhibitor composition including the naphthalene disulfonate was effective to substantially reduce the corrosion loss of the aluminum coupons in this experiment as compared to untreated water, and as compared to a corrosion inhibition composition with other organic acids (e.g., sebacic acid, octanoic acid, decanoic acid) and nitrate alone. Naphthalene disulfonate is also a fluorescent molecule with a fluorescent signal that is detectable at concentrations within the range of this example. Accordingly, the naphthalene disulfonate can be accurately quantified in the closed loop system using the techniques described above, and this quantification can be used to more accurately control the dosing of the corrosion inhibitor composition.

### Mild Steel Corrosion Examples

In the following experiments, the corrosion rates of mild steel coupons were measured over 18 hours in the presence of the corrosion inhibition compositions shown below:

Comparative example 1: 26.4 wt. % of a 45% KOH solution, 14.00 wt. % sebacic acid, 2.00 wt. % sodium triazole, 4.00 wt. % borax, 6.00 wt. % octanoic/decanoic acid, 0.5 wt. % PMA (polymaleic acid), 0.1 wt. % of an anti-foaming agent, and balance RO (reverse osmosis) water.

Comparative example 2: 2.73% of a 38% solution of an AA (acrylic acid)/AMPS copolymer, 3.91 wt. % of a 50% NaOH solution, 2.55 wt. % of a 50% solution of hydroxyphosphonoacetic acid (Belcor® 575), 2.55 wt. % of a 38% solution of polyaspartic acid, 2.55 wt. % of a 90% solution of a benzotriazole/tolytriazole blend, and balance RO water.

Comparative Example 3: 96.20 wt. % of a 40% sodium nitrite solution, 1.50 wt. % of a 50% NaOH solution, and 0.30 wt. % borax.

Naphthalene derivative example: 13.2 wt. % of a 45% KOH solution, 7.00 wt. % 2,6-naphthalene dicarboxylic acid, 1.00 wt. % sodium triazole, 2.00 wt. % borax, 3.00 wt. % octanoic/decanoic acid, 0.25 wt. % PMA, 0.05 wt. % of an anti-foaming agent, and balance RO water.

Sample water was prepared having 35 ppm sulfate, 15 ppm chloride, 50 ppm Malk as CaCO₃, and the pH was adjusted to 9.7 with sulfuric acid. The water temperature was maintained at 70° C. and the water was stirred at a rate of 350 rpm. Mild steel coupons (4.5 cm² C1010MS coupons) were placed in samples of the water and the corrosion inhibition compositions were dosed in the amounts shown in Table 2 below. The “control” includes no corrosion inhibition composition. The corrosion rate (mpy) was measured over 18 hours, and the average corrosion rate from 10-18 hours was calculated. The results are shown below.

TABLE 2

| | | 750 ppm | 1250 ppm | 3000 ppm | 1500 ppm | 1500 ppm |
|---|---|---|---|---|---|---|
| Time | | Comp. | Comp. | Comp. | Comp. | Naphthalene |
| (hrs) | Control | Ex. 1 | Ex. 1 | Ex. 2 | Ex. 3 | Deriv. Ex. |
| 0 | 16.77 | 0.06 | 0.41 | 4.08 | 0.26 | 0.03 |
| 1 | 13.53 | 0.19 | 0.35 | 3.99 | 0.11 | 0.05 |
| 2 | 13.55 | 0.20 | 0.26 | 4.45 | 0.08 | 0.08 |
| 3 | 13.08 | 0.22 | 0.23 | 4.15 | 0.07 | 0.06 |
| 4 | 12.45 | 0.16 | 0.19 | 3.71 | 0.08 | 0.06 |
| 5 | 12.20 | 0.14 | 0.16 | 3.66 | 0.05 | 0.07 |
| 6 | 11.53 | 0.15 | 0.14 | 3.60 | 0.07 | 0.04 |
| 7 | 10.95 | 0.14 | 0.15 | 3.84 | 0.04 | 0.05 |
| 8 | 10.43 | 0.14 | 0.16 | 3.34 | 0.07 | 0.09 |
| 9 | 9.99 | 0.15 | 0.14 | 3.25 | 0.12 | 0.08 |
| 10 | 9.74 | 0.15 | 0.15 | 3.40 | 0.08 | 0.08 |
| 11 | 9.37 | 0.15 | 0.15 | 2.93 | 0.14 | 0.09 |
| 12 | 8.77 | 0.15 | 0.11 | 2.74 | 0.12 | 0.07 |
| 13 | 8.42 | 0.08 | 0.09 | 2.58 | 0.13 | 0.08 |
| 14 | 8.41 | 0.12 | 0.11 | 2.94 | 0.12 | 0.09 |
| 15 | 8.12 | 0.08 | 0.13 | 2.77 | 0.12 | 0.08 |
| 16 | 7.77 | 0.08 | 0.12 | 2.69 | 0.13 | 0.10 |
| 17 | 7.46 | 0.08 | 0.09 | 2.72 | 0.08 | 0.07 |
| 10-18 hr | 8.39 | 0.11 | 0.12 | 2.80 | 0.11 | 0.08 |
| average | | | | | | |

It can be seen from the above results that the corrosion inhibitor composition including the naphthalene derivative was effective to substantially inhibit corrosion of mild steel surfaces over an extended time period, and showed improved results compared to treatment compositions that include only nitrite and treatment compositions that include only organic acids as corrosion inhibitors.

### Engine Coolant Corrosion Examples

The following experiments are intended to be predictive of corrosion inhibition behavior in an engine coolant closed loop system. An example corrosion inhibitor composition identified in Table 1 below were prepared by adding 0.15 wt. % of naphthalene disulfonate in an ethylene glycol/water solution that also contain solvent PMA, potassium hydroxide, sebacic acid, octanoic/decanoic acid, sodium tolytriazole, borax, and an antifoam agent (L-61). For comparison, (i) a similar composition was prepared without the naphthalene disulfonate, and (ii) a similar composition was prepared with 0.15 wt. % of sodium nitrate.

These treatment compositions were dosed at 33.3 wt. % and the corrosion loss (mg) was determined according to the test parameters outlined in ASTM D1384 (2019) on various metallurgies. The results are shown below in Table 3 below.

TABLE 3

| | Closed Loop Engine Coolant | | |
|---|---|---|---|
| Component | Composition (%) Dosed at 33.3% | | |
| RO Water | 5.03 | 4.88 | 4.88 |
| Ethylene Glycol | 90.00 | 90.00 | 90.00 |
| PMA | 0.10 | 0.10 | 0.10 |
| 50% KOH | 2.36 | 2.36 | 2.36 |
| Sebacic Acid | 1.47 | 1.47 | 1.47 |
| Octanoic/Decanoic | 0.63 | 0.63 | 0.63 |
| Acid | | | |
| Sodium Tolytriazole | 0.20 | 0.20 | 0.20 |
| Borax | 0.20 | 0.20 | 0.20 |
| L-61 | 0.02 | 0.02 | 0.02 |
| Sodium Nitrate | — | 0.15 | — |
| Naphthalene | — | — | 0.15 |
| Disulfonate | | | |
| Solder Loss (mg) | 7.6 | 5.4 | 3.8 |
| Cast Aluminum Loss | 3.2 | 0.1 | 3.4 |
| (mg) | | | |
| Copper Loss (mg) | 1.2 | 1.6 | 1 |
| Brass Loss (mg) | 0.4 | 0.5 | 0.3 |
| Cast Iron Loss (mg) | 0.8 | 0 | −0.6 |
| Steel Loss (mg) | 2.7 | 2.8 | 0.7 |

It can be seen from the above results that, for engine coolant applications, the corrosion inhibitor composition including the naphthalene disulfonate was at least effective or more effective than sodium nitrate in inhibiting corrosion on surfaces made from solder, copper, brass, cast iron, and steel.

### Standard Curve Validation Example

A traced corrosion inhibition composition (labeled as “Traced OAT Product” in the FIGURE) was prepared with the following make up: 26.4 wt. % of a 45% KOH solution, 1.00 wt. % of a 50% PMA, 13.00 wt. % sebacic acid, 6.00 wt. % of an octanoic/decanoic acid blend, 1.00 wt. % of 2,6-naphthalene dicarboxylic acid, 4.00 wt. % of a 50% solution of sodium tolytriazole, 0.1 wt. % of an anti-foaming agent, and 0.05 wt. % of a 10% PTSA solution.

Varying amounts of the corrosion inhibition composition were added to water (100 ppm, 500 ppm, 1,000 ppm, and 2,500 ppm) and the maximum fluorescence emission intensity at 368 nm was measured by a fluorimeter at an excitation wavelength of 302 nm. A second order polynomial standard curve was fit to the data to provide the standard curve that is shown in the FIGURE. As can be seen, the fluorescence signal intensities of the sample exhibited a good correlation with concentration as a second order polynomial relationship.

To validate the standard curve, the fluorescence intensity of a sample prepared with 1600 ppm of the corrosion inhibition composition was measured. The emission intensity was measured to be 268824 AU, and the product concentration was calculated from the standard curve to be 1638.9 ppm or 16.4 ppm of active naphthalene derivative compound.

It will be apparent to those skilled in the art that variations of the methods and compositions described herein are possible and are intended to be encompassed within the scope of the present invention.

What is claimed is:

1. A method for treating a closed loop system that includes a corrodible metal surface, the method comprising:
providing a heat transfer fluid that is in contact with the corrodible metal surface and includes a naphthalene dicarboxylic acid;
measuring a fluorescence signal of the naphthalene dicarboxylic acid in the heat transfer fluid; and
determining an amount of the naphthalene dicarboxylic acid in the heat transfer fluid based on the measured fluorescence signal.

2. The method of claim 1, wherein the corrodible metal surface is aluminum.

3. The method of claim 1, wherein the corrodible metal surface is mild steel or carbon steel.

4. The method of claim 1, wherein the naphthalene dicarboxylic acid is present in the heat transfer fluid in amounts of from 10 ppb to 2,000 ppm.

5. The method of claim 1, further comprising adding an additional amount of the naphthalene dicarboxylic acid to the heat transfer fluid based on the determined amount of the naphthalene dicarboxylic acid in the heat transfer fluid.

6. The method of claim 1, further comprising comparing the determined amount of the naphthalene dicarboxylic acid to a predetermined threshold amount, and adding an additional amount of naphthalene dicarboxylic acid to the closed loop system if the determined amount of the naphthalene dicarboxylic acid is below the predetermined threshold amount.

7. The method of claim 1, wherein the naphthalene dicarboxylic acid is selected and present in the heat transfer fluid in an amount so that the corrodible metal surface exhibits a corrosion rate of less than 1 mpy over at least a consecutive eight hour period.

8. The method of claim 7, wherein the corrodible metal surface is a carbon steel surface.

9. A method for treating a closed loop system that includes a heat transfer fluid that is in contact with a corrodible metal surface that is selected from an aluminum surface, a mild steel surface, and a carbon steel surface, the method comprising:
adding a corrosion inhibition composition to the heat transfer fluid, which includes a corrosion inhibition compound that has a fluorophore group and is effective to inhibit corrosion of the corrodible metal surface; and
then measuring a fluorescence signal of the corrosion inhibition compound in the heat transfer fluid.

10. The method of claim 9, wherein the fluorophore group includes a plurality of combined aromatic groups.

11. The method of claim 9, wherein the fluorophore group includes a naphthalene group.

12. The method of claim 9, wherein the corrosion inhibition compound can be represented by formula (I) below 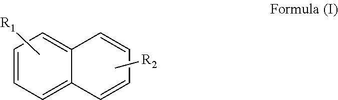
in which at least one of R1 and R2 includes (i) a sulfonic acid group (—SO₂OH) or anions, salts, or esters thereof; or (ii) a carboxylic acid group, or anions, salts, or esters thereof.

13. The method of claim 12, wherein R1 and R2 are the same and are selected from the carboxylic acid group, or anions, salts, or esters thereof.

14. The method of claim 9, wherein the corrosion inhibition compound is a naphthalene dicarboxylic acid.

15. The method of claim 9, wherein the corrosion inhibition composition is added to the heat transfer fluid so that the corrosion inhibition compound is present in the heat transfer fluid in an amount of from 10 ppm to 1,500 ppm.

16. The method of claim 9, wherein the corrosion inhibition composition further includes at least one organic acid compound selected from a C6-C14 aliphatic dicarboxylic acid and a C6-C14 aliphatic monocarboxylic acid.

17. The method of claim 16, wherein the corrosion inhibition compound is a naphthalene derivative and wherein the corrosion inhibition composition includes the naphthalene derivative and the at least one organic acid compound in a weight ratio that is in a range of from 1:20,000 to 1:1.

18. The method of claim 9, wherein the corrosion inhibition compound is selected and added to the heat transfer fluid in an amount so that the corrodible metal surface exhibits a corrosion rate of less than 1 mpy over at least a consecutive eight hour period.

19. The method of claim 9, wherein the corrosion inhibition compound is selected and added to the heat transfer fluid in an amount so that the corrodible metal surface exhibits a corrosion rate of less than 0.5 mpy over at least a consecutive eight hour period.

20. The method of claim 19, wherein the corrodible metal surface is the carbon steel surface.

21. The method of claim 12, wherein the corrosion inhibition composition further includes at least one azole.

22. The method of claim 21, wherein the corrosion inhibition compound is a naphthalene derivative and wherein the corrosion inhibition composition includes the naphthalene derivative and the at least one azole in a weight ratio that is in a range of from 1:2,000 to 10:1.

23. The method of claim 9, further comprising determining an amount of the corrosion inhibition compound in the heat transfer fluid based on the measured fluorescence signal, and controlling an additional amount of the corrosion inhibition compound that is added to the heat transfer fluid based on the determined amount of the corrosion inhibition compound in the heat transfer fluid.

24. A method for treating a closed loop system that includes a corrodible metal surface, the method comprising:
providing a heat transfer fluid that is in contact with the corrodible metal surface and includes (i) a naphthalene derivative, and (ii) at least one organic acid compound selected from a C6-C14 aliphatic dicarboxylic acid and a C6-C14 aliphatic monocarboxylic acid;
measuring a fluorescence signal of the naphthalene derivative in the heat transfer fluid; and
evaluating an amount of the naphthalene derivative in the heat transfer fluid based on the measured fluorescence signal.
